(19) United States
(12) Patent Application Publication
(10) Pub. No.: US 2015/0338869 A1
(43) Pub. Date: Nov. 26, 2015

(54) DEMAND RESPONSE CONTROL METHOD AND DEMAND RESPONSE CONTROL DEVICE

(71) Applicant: Panasonic Intellectual Property Management Co., Ltd., Osaka (JP)

(72) Inventor: MAHDI BEHRANGRAD, Osaka (JP)

(21) Appl. No.: 14/711,776

(22) Filed: May 14, 2015

(30) Foreign Application Priority Data
May 22, 2014 (JP) 2014-106432

(51) Int. Cl. G05F 1/66; G05B 15/02

(52) U.S. Cl. CPC G05F 1/66; G05B 15/02

(57) ABSTRACT

A demand response control method for an electric power storage device. The method includes: acquiring consumption power of a user and information about one or more demand response services with which the user has a contract; estimating a lifestyle pattern in a demand control period according to the consumption power; assigning one of a plurality of demand control services to the demand control period according to the lifestyle pattern and generating operation plan of one or more electric appliances to perform demand control services; and controlling the electric appliances according to the operation plan in the demand control period.

### BACKGROUND

1. Technical Field

The present disclosure relates to a demand response control method and a demand response control device.

2. Description of the Related Art

In recent years, Demand response (also referred to below as simply “DR”) service has been spread. Demand response is, for example, a system that adjusts power supply and demand between a power system and a consumer by controlling the consumer's electrical appliance in a time period during which the power supply and demand are likely to lose the balance.

For example, typical supply and demand control services (DR services) include “peak shaving” that reduces power consumption in a time period during which power demand is likely to lose the balance, “frequency regulation” that performs charging or discharging based on a command value to adjust the frequency of a power system, and “reserve capacity supply” that provides a power system with reserve capacity.

U.S. Patent Application Publication No. 2013/0173079 is an example of related art.

### SUMMARY

To provide a supply and demand adjustment service (a DR service), an electrical appliance owned by a user needs to be controlled in response to details of the supply and demand adjustment service. Therefore, when the supply and demand adjustment service is increasingly provided, there may be an increase in time when the user cannot be free to use the electrical appliance, causing a loss of the user's comfort.

One non-limiting and exemplary embodiment provides a demand response control method and a demand response control device that can provide a supply and demand adjustment service in consideration of an influence on a user's comfort.

In one general aspect, the techniques disclosed here feature a demand response control method for an electric power storage device. The method includes: acquiring consumption power of a user; acquiring information about one or more demand response services with which the user has a contract; estimating a lifestyle pattern in a demand control period according to the consumption power; assigning one of a plurality of demand control services to the demand control period according to the lifestyle pattern and generating operation plan of one or more electric appliances to perform demand control services; and controlling the electric appliances according to the operation plan in the demand control period.

The demand response control method and the demand response control device according to one aspect of the present disclosure can provide a supply and demand adjustment service in consideration of an influence on a user's comfort.

It should be noted that these generic or specific embodiments may be implemented as a system, a method, an integrated circuit, a computer program, a computer-readable recording medium such as a CD-ROM, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a system configuration diagram of a DR system according to a first embodiment;

FIG. 2A is a first diagram illustrating a relationship between a user's home load and time;

FIG. 2B is a second diagram illustrating a relationship between the user's home load and time;

FIG. 2C is a third diagram illustrating a relationship between the user's home load and time;

FIG. 3 is a block diagram illustrating a configuration of a DR controller according to the first embodiment;

FIG. 4 is a sequence diagram illustrating an exchange of information among devices when a DR service is executed;

FIG. 5 illustrates input data required to determine a lifestyle pattern and output data created as a result of determination;

FIG. 6 illustrates an overview of creation of lifestyle pattern data by an analyzer;

FIG. 7A is a first diagram illustrating an influence of DR service execution on the user;

FIG. 7B is a second diagram illustrating an influence of DR service execution on the user;

FIG. 7C is a third diagram illustrating an influence of DR service execution on the user;

FIG. 8 illustrates an overview of DR service scheduling performed by a planner;

FIG. 9A is a first diagram illustrating DR service allocation;

FIG. 9B is a second diagram illustrating DR service allocation;

FIG. 9C is a third diagram illustrating DR service allocation;

FIG. 10A is a first diagram illustrating scheduling by the planner;

FIG. 10B is a second diagram illustrating scheduling by the planner;

FIG. 10C is a third diagram illustrating scheduling by the planner; and

FIG. 11 is a system configuration diagram illustrating a configuration of a DR system including a server that coordinates a plurality of DR controllers.

### DETAILED DESCRIPTION

A demand response control method according to one aspect of the present disclosure a demand response control method for an electric power storage device, the method includes: acquiring consumption power of a user; acquiring information about one or more demand response services with which the user has a contract; estimating a lifestyle pattern in a demand control period according to the consumption power; assigning one of a plurality of demand control services to the demand control period according to the lifestyle pattern and generating operation plan of one or more electric appliances to perform demand control services; and controlling the electric appliances according to the operation plan in the demand control period.

Moreover, the demand control service may be a peak shaving control or a frequency control.

Moreover, the lifestyle pattern may be one of “active at home”, “inactive at home”, “getting up”, “sleeping”, and “absence”.

Moreover, the demand response service may include service for a reduction of power consumption of the electrical appliance, and the service for a reduction of power consumption is assigned to the demand control period if the lifestyle pattern is “sleeping”.

Moreover, the demand response service includes service for a reduction of power consumption of the electrical appliance, and the service for a reduction of power consumption is not assigned to the demand control period if the lifestyle pattern is “absence”.

A demand response control device according to one aspect of the present disclosure a demand response control device for an electric power storage device, the device includes: one or more memories; and circuitry operative to: acquire consumption power of a user; acquire information about one or more demand response services with which the user has a contract; estimate a lifestyle pattern in a demand control period according to the consumption power; assign one of a plurality of demand control services to the demand control period according to the lifestyle pattern and generating operation plan of one or more electric appliances to perform demand control services; and control the electric appliances according to the operation plan in the demand control period.

A demand response control method according to one aspect of the present disclosure adjusts power supply and demand in a power system by controlling an electrical appliance in a supply and demand adjustment period. The demand response control method includes acquiring a user's lifestyle pattern information, acquiring information about a supply and demand adjustment service with which the user has a contract, estimating a lifestyle pattern of the user in the supply and demand adjustment period using the acquired lifestyle pattern information, planning based on the estimated lifestyle pattern and the supply and demand adjustment service information, generates an operation plan for the electrical appliance for executing the supply and demand adjustment service in the supply and demand adjustment period, and controlling the electrical appliance in accordance with the operation plan in the supply and demand adjustment period.

Moreover, in the supply and demand adjustment period (demand control period), the plurality of supply and demand adjustment services may be execution targets, and in the planning step, one of the plurality of supply and demand adjustment services may be selected based on the lifestyle pattern and the operation plan may be generated in which the selected one supply and demand adjustment service is allocated to the supply and demand adjustment period.

Moreover, after the planning step, a third acquisition step that acquires a state of the user in the supply and demand adjustment period and an update step that, when there is a change in the state of the user acquired in the third acquisition step from the lifestyle pattern of the user acquired in the first acquisition step, updates the operation plan based on the state of the user may be further included, and in the execution step, the electrical appliance may be controlled in accordance with the updated operation plan.

Moreover, after the planning step, a fourth acquisition step that acquires a state of another user in the supply and demand adjustment period may be further included, and in the update step, the operation plan may be updated based on the state of the user acquired in the third acquisition step and the state of the other user acquired in the fourth acquisition step.

Moreover, the supply and demand adjustment service may include a supply and demand adjustment service in which reduction of power consumption of the electrical appliance is requested, and in the planning step, the supply and demand adjustment service in which reduction of power consumption of the electrical appliance is requested may be allocated to the supply and demand adjustment period that is estimated as a period during which the user is sleeping.

Moreover, the supply and demand adjustment service may include a supply and demand adjustment service in which reduction of power consumption of the electrical appliance is requested, and in the planning step, the supply and demand adjustment service in which reduction of power consumption of the electrical appliance is requested may not be allocated to the supply and demand adjustment period that is estimated as a period during which the user stays out.

A demand response control device according to one aspect of the present disclosure adjusts power supply and demand in a power system by controlling an electrical appliance in a supply and demand adjustment period. The demand response control device includes a first acquirer that acquires a user's lifestyle pattern information, a second acquirer that acquires information about a supply and demand adjustment service with which the user has a contract, an estimator that estimates a lifestyle pattern of the user in the supply and demand adjustment period using the acquired lifestyle pattern information, a planner that, based on the estimated lifestyle pattern and the supply and demand adjustment service information, generates an operation plan for the electrical appliance for executing the supply and demand adjustment service in the supply and demand adjustment period, and an executor that controls the electrical appliance in accordance with the operation plan in the supply and demand adjustment period.

A demand response control method according to one aspect of the present disclosure adjusts power supply and demand in a power system by controlling an electrical appliance owned by a user in a supply and demand adjustment period. The demand response control method includes a step that acquires information about an action schedule indicating an expected action of the user, a step that generates a control schedule for the electrical appliance in the supply and demand adjustment period to adjust the power supply and demand, a step that compares the acquired action schedule and the generated control schedule to determine whether power supply and demand in the supply and demand adjustment period can be adjusted, and a step that, when it is determined that the power supply and demand can be adjusted, controls the electrical appliance in accordance with the control schedule in the supply and demand adjustment period.

Moreover, a step that, when it is determined that the power supply and demand cannot be adjusted, displays advice information for enabling adjustment of the power supply and demand on a predetermined displayer may be further included.

Moreover, a step that, when it is determined that the power supply and demand cannot be adjusted, displays information about a user loss due to non-adjustment of the power supply and demand on a predetermined displayer may be further included.

A demand response control device according to one aspect of the present disclosure adjusts power supply and demand in a power system by controlling an electrical appliance owned by a user in a supply and demand adjustment period. The demand response control device includes an acquirer that acquires information about an action schedule indicating an expected action of the user, and a controller that generates a control schedule for the electrical appliance in the supply and demand adjustment period to adjust the power supply and demand, compares the action schedule acquired by the acquirer and the generated control schedule to determine whether power supply and demand in the supply and demand adjustment period can be adjusted, and, when it is determined that the power supply and demand can be adjusted, controls the electrical appliance in accordance with the control schedule in the supply and demand adjustment period.

It should be noted that these general or specific embodiments may be implemented as a system, a device, an integrated circuit, a computer program, a recording medium, or any selective combination thereof.

Embodiments will now be described specifically with reference to the drawings. In the embodiments described below, demand response may be referred to as simply “DR” or “supply and demand adjustment”.

All the embodiments described below illustrate generic or specific examples. Numeric values, shapes, materials, components, arrangement positions and connection modes of the components, steps, sequences of the steps, and the like illustrated in the embodiments below are examples and do not have the effect of limiting the present disclosure. In addition, of the components in the embodiments below, the components that are not described in independent claims that indicates top concepts are described as arbitrary components.

The drawings are schematic diagrams and not necessarily illustrated exactly. In the drawings, substantially the same components are given the same reference numerals, and repeated descriptions may be omitted or simplified.

### First Embodiment

### [Overall Configuration]

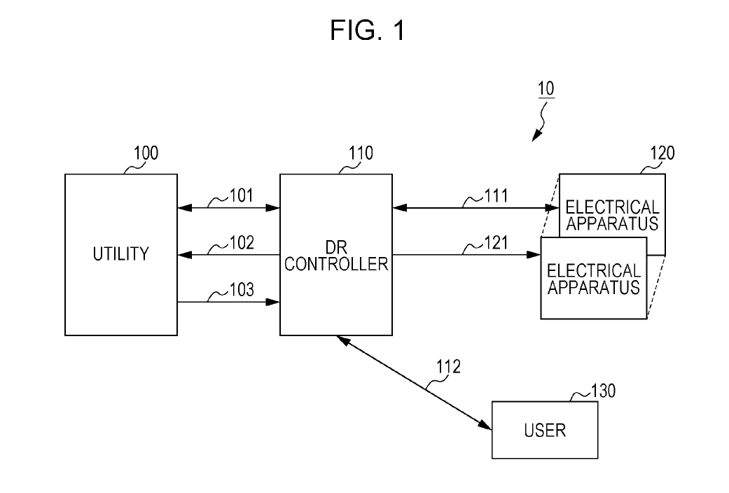

A configuration of a DR system according to a first embodiment will first be described. FIG. 1 is a system configuration diagram of the DR system according to the first embodiment.

As illustrated in FIG. 1, a DR system 10 according to the first embodiment includes a utility 100, a DR controller 110, and one or more electrical appliances 120. A user who owns a plurality of electrical appliances is also illustrated in FIG. 1.

The utility 100 transmits and receives data 101 to and from the DR controller 110. In the first embodiment, the utility 100 is, for example, a server used by a power company. The utility 100 may be an aggregator, an energy retailer, a power system operator, or the like. The aggregator is a business operator that carries out power supply and demand adjustment business.

The DR controller 110 provides a service 102 (for example, a DR service) to the utility 100. That is, the DR controller 110 controls the electrical appliance 120 in response to details of the DR service. The DR controller 110 transmits a control signal 121 to the electrical appliance 120 when performing the control.

The utility 100 pays a consideration 103 to a user 130 based on the provided DR service. FIG. 1 illustrates a case in which the utility 100 transmits information about the consideration 103 to the DR controller 110. Accordingly, in cases such as one in which the DR controller 110 includes a display (displayer), the DR controller 110 can display consideration information on the display when the utility 100 transmits the information about the consideration 103 to the DR controller 110.

The consideration information does not necessarily have to be transmitted to a server 150, and may be displayed on a mobile telephone, a personal computer, or the like of the user 130 from the utility 100 or the DR controller 110.

Moreover, the consideration to be given to the user 130 does not necessarily have to be money, and points or the like may be given to the user 130.

Moreover, the DR controller 110 transmits and receives data 111 to and from the electrical appliance 120. The DR controller 110 provides data 112 to the user 130 (or acquires data from the user 130).

The DR controller 110 is a control device that can control the electrical appliance 120 owned by the user 130. The DR controller 110 is, for example, a smart meter that manages power consumption in a user home, a home energy management system (HEMS) controller that controls the electrical appliance 120 in a home of the user 130, a smart thermostat that controls a water heater owned by the user 130, or the like.

The electrical appliance 120 is an electrical appliance for which the user 130 has the use right. The electrical appliance 120 is, for example, an air conditioner (AC), an electrical water heater, an IH cooking heater, an electrical motor, a battery, a fuel cell, a solar cell, a wind power generator, or the like. The battery is not limited to a stationary electricity storage system such as a UPS, and may be a battery mounted on an electrical vehicle. The electrical appliance 120 may be any appliance that performs at least one of the consumption, production, and storage of power (electrical energy).

The service 102 is control for performing power supply and demand adjustment in a power system managed by the utility 100. The service 102 is, for example, reserve capacity supply, peak shaving (peak cut), an energy conservation service, an interruptible load, frequency regulation (frequency control), time of use (TOU), a real-time pricing (RTP), or the like, but is not limited thereto.

In the DR system 10 as described above, the DR controller 110 estimates (also referred to below as determines) a lifestyle pattern of the user 130 and makes an execution plan for a DR service. Some DR services require a contract (tender) with the utility 100 in advance, and it becomes more important to make a plan in advance to provide such DR services.

### [Lifestyle Pattern Determination]

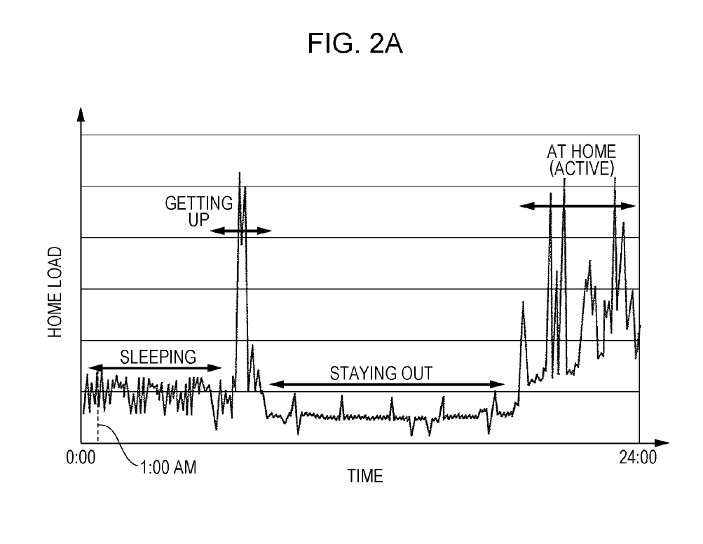

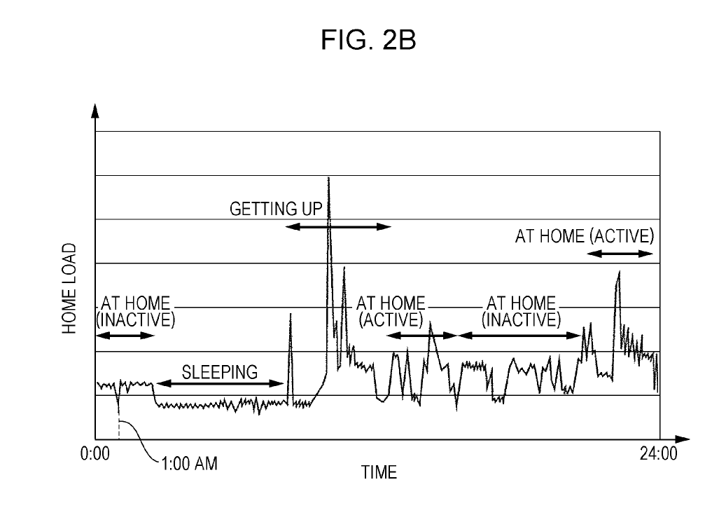

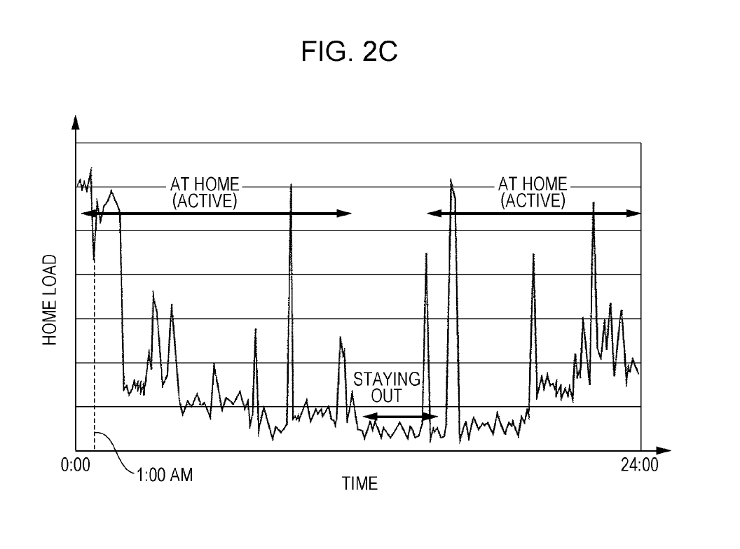

In the first embodiment, a day is classified into one or more periods and a lifestyle pattern is determined for each period. The lifestyle pattern is determined depending on a use pattern of the electrical appliance 120. This is because the use pattern of power changes due to an action of the user 130. FIGS. 2A, 2B, and 2C illustrate relationships between a home load of the user 130 and time. The home load is, namely, power consumption in the home. FIGS. 2A, 2B, and 2C illustrate, as examples, relationships between five lifestyle patterns “getting up”, “at home (inactive)”, “at home (active)”, “staying out”, and “sleeping” and the home load.

These five lifestyle patterns can be classified by, for example, the number of load fluctuations, an average value of power consumption, or a momentary value of power consumption.

For example, time periods during which the average value of power consumption is low are classified into “at home (inactive)”, “sleeping”, and “staying out”. Further, for example, time periods during which the average value of power consumption is large are classified into “at home (inactive)”, “sleeping”, and “staying out” in descending order of the average value of power consumption.

Moreover, time periods during which a load fluctuation occurs frequently in the home, time periods during which the average value of power consumption is high, and time periods during which a load is momentarily high are distinguished as “at home (active)” or “getting up”. For example, when time periods during which a load becomes momentarily high occur, the time periods can be estimated as “getting up”, and time periods during which a load fluctuation occurs continuously can be estimated as “at home (active)”.

A method of classification of lifestyle patterns described in the present embodiment is merely an example, and such a classification method is not a limitation.

As illustrated in FIGS. 2A, 2B, and 2C, home load shifts and fluctuations are more largely influenced by lifestyle habits of the user 130 than by time periods. For example, even at the same time of day of 1:00 AM, a large home load fluctuation may occur if the user 130 is at home, but a large home load fluctuation does not occur if the user 130 is sleeping.

These lifestyle patterns cannot be predicted completely even for the user 130. This is because the lifestyle patterns are influenced by the user's actions. For example, the lifestyle patterns are influenced by many factor parameters such as a sudden visitor, job rescheduling, a change in time of sleep, and an unexpected social event. The home load fluctuations illustrated in FIGS. 2A to 2C are based on the following examples.

FIG. 2A: “All of going home, sleeping, and getting up are as expected”

FIG. 2B: “Going home, sitting up late, the next day is off from work, but staying out for an early dinner”

FIG. 2C: “Going home early, having a visitor, and being active all night”

Informing the DR controller 110 of lifestyle patterns directly from the user is not practical. This is because the user does not know when to get up, when a visitor goes back, or whether the visitor falls asleep. Moreover, after long time has elapsed, the user may forget to inform the DR controller 110 of the lifestyle patterns, may be unable to inform the DR controller 110 of the lifestyle patterns, or further, may lose interest in informing the DR controller 110 of the lifestyle patterns.

Although FIGS. 2A to 2C illustrate the load fluctuations in the home in which the user 130 lives, lifestyle patterns can be defined in, for example, an office, a commercial facility, a factory, or the like, not in a house.

For example, lifestyle patterns in an office can be defined as follows.

Morning time period (get down to work and turn on the power to electrical appliances in the office)
Stay in the Office
Lunch break
Finish work and turn off the power to the electrical appliance in the office
Advance cooling at night
Nobody stays in the building, etc.

As described above, lifestyle patterns, that is, home load fluctuations influence the success or failure of a DR service. For example, in reserve capacity supply, which is one of the DR services, total home load must be maintained at a level lower than or equal to a predetermined value in time periods specified in a contract. Therefore, whether the reserve capacity supply can succeed (the contract is fulfilled) depends on the home load fluctuations, that is, the lifestyle patterns.

### [DR Controller Configuration]

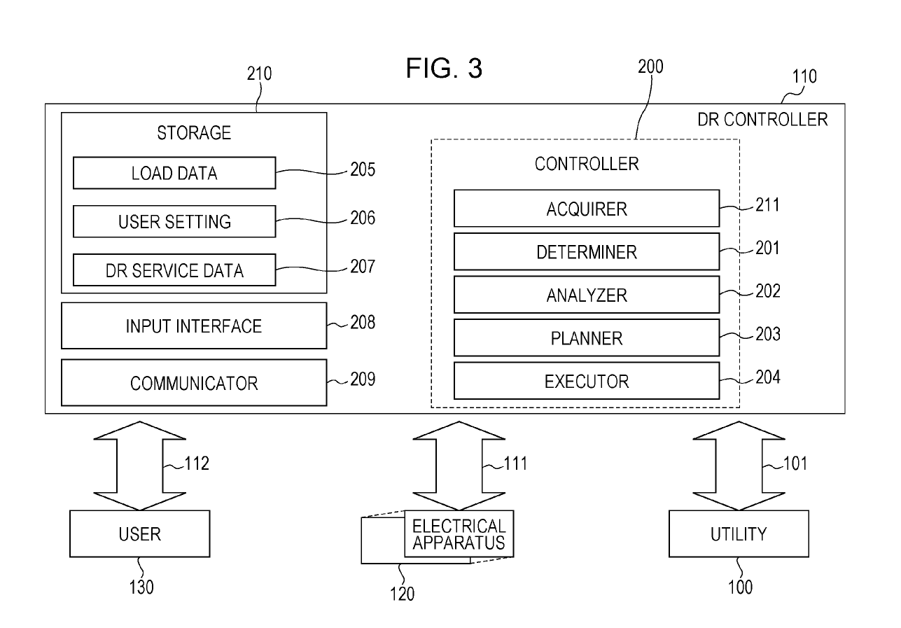

A configuration of the DR controller 110 will next be described. FIG. 3 is a block diagram illustrating the configuration of the DR controller 110 according to the first embodiment.

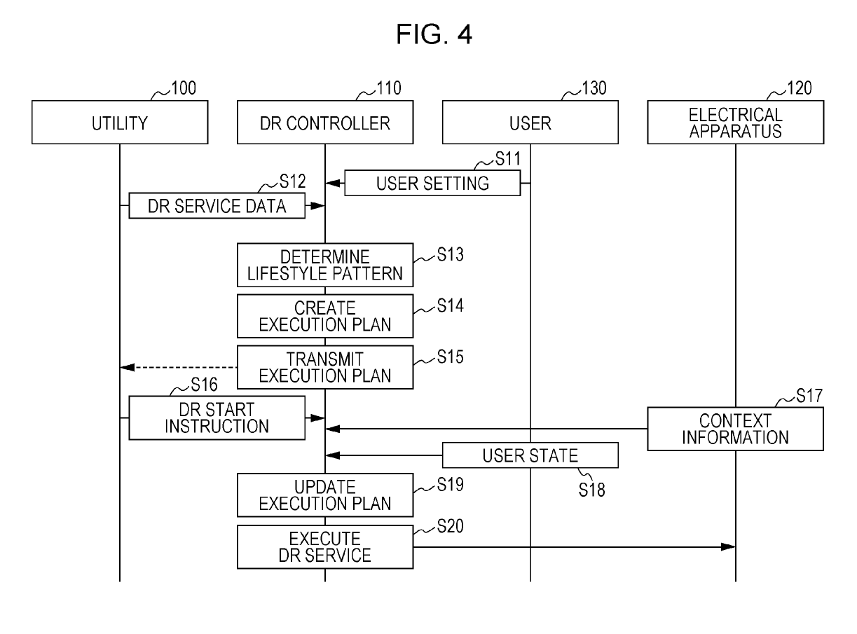

The DR controller 110 according to the first embodiment includes a controller 200, a communicator 209, and a storage 210. The DR controller 110 may include an input interface 208. The controller 200 includes an acquirer 211, a determiner 201, an analyzer 202, a planner 203, and an executor 204. Operation of each block will be described later in FIGS. 4 to 9C.

The input interface 208 accepts an input from the user 130. The input interface is, for example, a touch panel provided in the DR controller 110, hardware keys provided in the DR controller 110, or the like. The input from the user 130 to the DR controller 110 may be performed through a mobile terminal such as a smartphone.

The communicator 209 is a communication module by which the DR controller 110 communicates with the electrical appliance 120 and the utility 100. For communication by the communicator 209, any communication method (communication network), wired or wireless, may be used.

The storage 210 stores load data 205, a user setting 206, DR service data 207, and the like. The DR service data is, for example, details of a contract between the user and the utility. The DR service data includes information such as a load reduction amount, load interruption time, conditions under which a penalty occurs for the user 130, or an incentive that the user 130 can obtain in a supply and demand adjustment period. The storage 210 is, for example, semiconductor memory such as flash memory or electrically erasable programmable read-only memory (EEPROM), but there is no specific limitation.

The load data 205 is data that indicates at least the home load fluctuations (power consumption fluctuations) described above. The load data 205 may include any of the following data.

Total home load or a load in each electrical appliance 120 and energy distribution
State data for the electrical appliance 120 (for example, an operation mode, a temperature setting value, a state of charge (SOC), and the like for the electrical appliance 120)
Past use data for the electrical appliance 120 (for example, a use timing, a mode in which a use frequency is high, a use frequency, and the like)

The user setting 206 includes data as described below.

Whether the user 130 is present and an activity of the user 130 in the home
Setting value of comfort or functionality for each electrical appliance 120 or home (specifically, for example, an air conditioner temperature setting)
Specification of a DR service by the user 130

The DR service data 207 includes data as described below.

DR service contract details, an incentive that can be obtained at success (at fulfillment of the contract) or a penalty at failure (at nonfulfillment of the contract), a startup identifier, and a timing identifier
Any identifier that indicates an energy or demand fee and is used to start the DR service
DR service schedule

### [DR Controller Operation]

Operation of the DR controller 110 will next be described. FIG. 4 is a sequence diagram illustrating an exchange of information among devices when a DR service is executed.

First, the user 130 makes a user setting for the DR controller 110 (S11). As a result, a user setting in the storage 210 is rewritten. The user setting here is, for example, an allowable limit indoor temperature and the like set by the user 130.

Next, the acquirer 211 of the DR controller 110 acquires the DR service data 207 (S12). The acquired DR service data is stored in the storage 210. The DR service data includes, for example, information for executing the DR service, such as an energy fee package, DR contract details, DR operation conditions, an incentive that can be obtained, and a DR start timing.

Next, the planner 203 of the DR controller 110 allocates the DR service (S13). Specifically, the determiner 201 first determines to which lifestyle pattern a predetermined period (future period) identified by the DR service data 207 applies (S13).

Then, the analyzer 202 makes an analysis based on a determination result. The planner 203 creates a DR service execution plan by allocating the DR service that is an execution target in the predetermined period to the predetermined period based on the determination result (S14). At this time, the communicator 209 transmits the execution plan to the utility 100 as necessary (S15).

When the predetermined period actually approaches, the utility 100 creates information for starting the DR and transmits this information to the DR controller 110 (S16). The information for starting the DR is, namely, a DR start instruction, and includes, for example, a signal indicating the start time of reserve capacity supply, a peak cut signal, an energy fee, or the like.

Next, the communicator 209 receives context information from the electrical appliance 120 (S17). The context information here is, for example, an SOC when the electrical appliance 120 is a battery, or a setting temperature or the like when the electrical appliance 120 is an air conditioner.

Next, when the user 130 inputs a user state through the input interface 208, the acquirer 211 acquires this user state (S18). The user state here is information indicating an actual state of the user 130 in the above predetermined period (for example, “at home”, “staying out”, or the like). Then, the execution plan is updated in response to the user state acquired by the acquirer 211 (S19).

Finally, the executor 204 executes the DR service based on the execution plan. For example, the executor 204 generates and transmits the control signal 121 to the electrical appliance 120, and controls the electrical appliance 120 in response to the details of the DR service.

### [Lifestyle Pattern Determination]

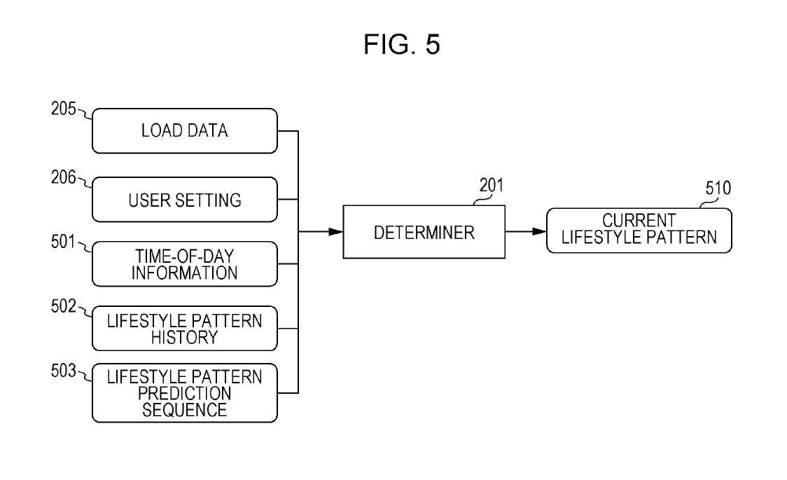

Processing for determining a lifestyle pattern by the determiner 201 will next be described. FIG. 5 illustrates input data required by the determiner 201 to determine the lifestyle pattern and output data created as a result of determination.

The determiner 201 determines a current lifestyle pattern 510 of the user 130 using the load data 205, the user setting 206, time-of-day information 501, lifestyle pattern history 502, and lifestyle pattern prediction sequence 503. The time-of-day information 501, the lifestyle pattern history 502, and the lifestyle pattern prediction sequence 503 may be acquired from the outside of the DR controller 110 or may be stored in the storage 210.

### [First Specific Example of Lifestyle Pattern Determination]

The determiner 201 makes a determination using the load data 205 (as an example, data indicating the total of power consumption in the electrical appliance 120 in the home as illustrated in FIG. 2A), but is assumed to be unable to access the load data for each electrical appliance 120 separately. As an example of this load data 205 may be load data when the DR controller 110 is a smart meter.

In this case, the determiner 201 determines a lifestyle pattern based on home load fluctuations included in the load data 205. The determiner 201 calculates the following load characteristics from the load data 205.

Momentary load change rate ((Δload/Δtime) in minutes)
Moving average data in X minutes (for example, X=15 minutes)
Load distribution function characteristic (for example, the maximum shift or the like from a moving average)

In the storage 210, a “determination rule” for determining a lifestyle step based on the calculated load characteristics, the load data 205, and the user setting 206 is stored. For example, a determination rule in a case in which a lifestyle pattern is determined as “sleeping” is as follows.

Moving average:
a [kW]<moving average [10 minutes]<b [kW], and this is not a rise pattern.
a and b are calculated form outdoor temperature c.
Load fluctuation:
d [kW]<real-time load<e [kW]
d and e here are decided based on a moving average, outdoor temperature c, a wind speed, and the size of a house.
Momentary load change rate:
A real-time load frequency between d [kW] and e [kW], and this has only to be smaller than f [number of times]. f here is a function of a season and the type of a day (working day, non-working day).
Previous lifestyle step:
When the lifestyle pattern of the previous period of a target period is “staying out”, the target period is not determined as “sleeping”. This determination is based on the lifestyle pattern prediction sequence 503.
Period:
When a target period is not determined as another lifestyle pattern including “staying out”, a target period belonging to between 1:00 and 7:00 in a weekday or between 2:00 and 9:00 in a non-working day is determined as “sleeping”. The times of day 1:00, 2:00, 7:00, and 9:00 here are decided based on the user's past “sleeping” timing (identified by the lifestyle pattern history 502).

### [Second Specific Example of Lifestyle Pattern Determination]

The determiner 201 may determine a lifestyle pattern using a determination rule described below. This determination rule is a rule in consideration of at least the type of the electrical appliance 120, time, a schedule, the user setting 206, and the lifestyle pattern of the previous period (lifestyle pattern prediction sequence 503) (a case in which a target period is determined as a lifestyle pattern of “sleeping” is described below).

Activity detection:
There is no activity of a person detected in a residence for X minutes or longer (activities of the person are detected by a thermal imaging sensor of an air condition or the like).
Electrical appliance 120 not in use:
A lighting fixture of a bedroom, a TV, and an IH cooking heater are not used.
Electrical appliance 120 in use:
An air conditioner of a bedroom is used during the summer.
Period:
When a target period is not determined as another lifestyle step, a target period belonging to between 1:00 and 7:00 in a weekday or between 2:00 and 9:00 in a non-working day is determined as “sleeping”. The times of day 1:00, 2:00, 7:00, and 9:00 here are decided based on the user setting 206.

The above lifestyle pattern determination assumes the resident user 130, but a similar determination can also be made for lifestyle patterns defined in an office, a factory, or the like as described above. A determination rule is defined based on a combination of the following parameters and is built into the DR controller 110 by the user 130, the utility 100, or an aggregator (for example, the determination rule is stored in the storage 210).

Load or energy distribution and load fluctuation characteristics
Rate at which the user is at home and activities of the user
Time-of-day information 501 (schedule and time information)
State information for the electrical appliance 120
Past use history of the electrical appliance 120
Mapping data for the electrical appliance 120 and a lifestyle pattern (for example, association data indicating which electrical appliance 120 is used in which lifestyle pattern)

### [Third Specific Example of Lifestyle Pattern Determination]

For example, a rule for linking a lifestyle pattern defined in an office with the load data 205 may be as follows.

When only the central air conditioner is on and the lighting fixture is off, the period is determined as a lifestyle pattern of advance cooling.
When the central air conditioner is on and the power to the electrical pot and PCs is on, the time period is determined as a lifestyle pattern of a morning time period.
When a period is included between 11:30 and 13:30 and the PCs and notebook computers are off, the period is determined as a lifestyle pattern of a lunch break if the period is in a working day.
When the central air conditioner is off, the PCs are off, the main lighting fixture is off, and the lighting fixture of the entrance is on, it is determined that workers have gone home. That is, it is determined that nobody stays in the building.

### [Lifestyle Pattern Analysis]

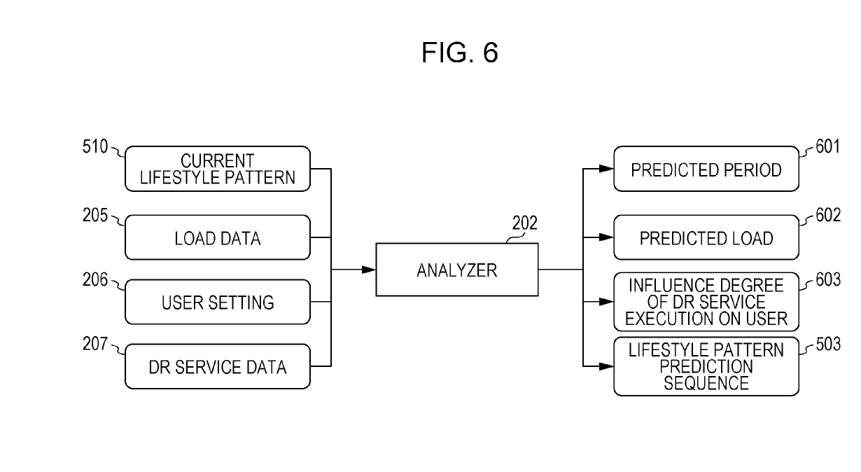

Next, the analyzer 202 analyzes the determined lifestyle pattern and creates lifestyle pattern data. FIG. 6 illustrates an overview of creation of lifestyle pattern data by the analyzer 202. As illustrated in FIG. 6, the data created by the analyzer 202 includes the following.

Predicted period 601 for the current lifestyle pattern 510 (period during which the current lifestyle pattern is predicted to continue)
Predicted load 602 in the current lifestyle pattern 510 (power consumption fluctuation)
Lifestyle pattern prediction sequence 503 (lifestyle pattern predicted to follow)
Influence degree 603 of DR service execution on the user

The predicted period 601, the predicted load 602, and the prediction sequence 503 may be predicted using the data that has been described or may be defined by the user.

### [Influence of DR Service Execution on the User]

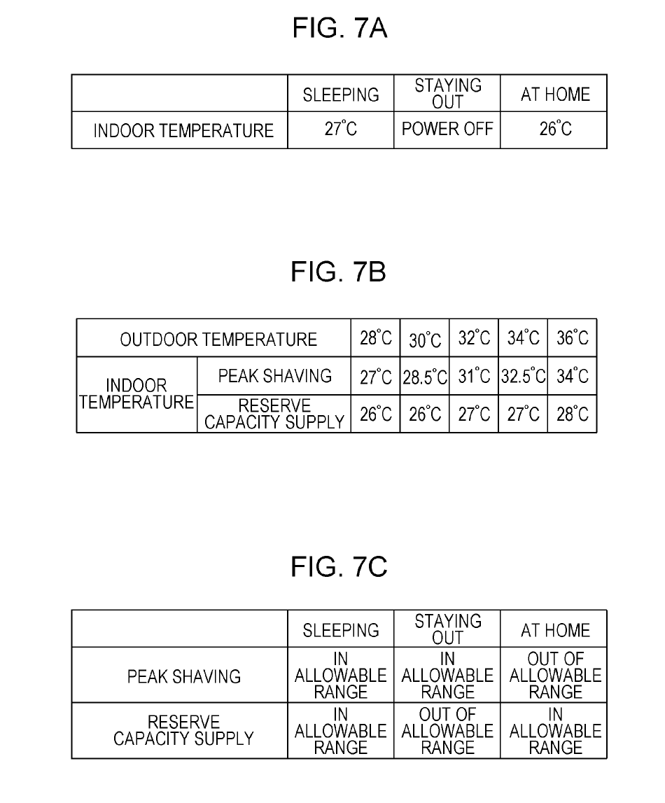

An influence of DR service execution on the user will now be described with reference to FIGS. 7A, 7B, and 7C. FIGS. 7A, 7B and 7C illustrate the influence of DR service execution on the user.

It is assumed that on a summer working day, the electrical appliance 120 is an air conditioner. It is assumed that the storage 210 of the DR controller 110 stores an allowable limit temperature for the user 130 based on the value of the user setting 206 or an allowable limit temperature for the user 130 learned from the past air conditioner use history.

For example, it is assumed that in a lifestyle pattern of “sleeping” for the user 130, there is a use history that indicates when an indoor temperature reaches 27° C., execution of the current DR service is usually canceled and normal operation of the air conditioner is started. From such a use history, the planner 203 creates a functionality list for the electrical appliance 120 as illustrated in FIG. 7A. In the example in FIG. 7A, the functionality here is an indoor temperature.

Moreover, as illustrated in FIG. 7B, the planner 203 can simulate how the functionality for the electrical appliance 120 (for example, an indoor temperature) changes when DR services (peak shaving and reserve capacity supply here) are executed.

For example, when the electrical appliance 120 is an air conditioner, an influence of execution of various DR services on the functionality for the electrical appliance 120 can be simulated as described below.

Estimated DR service period:
The planner 203 can predict or estimate the length of a period during which the air conditioner is shut down for each DR service from the past data or the contract details. For example, for peak shaving, one hour of power consumption reduction is predicted to be required by the contract, and for reserve capacity supply, about 20 minutes is predicted to be required from the past data. Such a period identifier (included in the DR service data) is transmitted by the utility 100 to the DR controller 110.
Environment information:
The planner 203 considers information such as an outdoor temperature, a time of day, and a wind speed.

Then, as illustrated in FIG. 7C, the planner 203 determines whether an influence of DR service execution (change in indoor temperature) is in the allowable range (whether the requirements in FIG. 7A are satisfied) or out of the allowable range for the user 130.

Thus, the planner 203 makes a DR service execution plan in consideration of an influence of DR service execution on the user.

### [DR Service Scheduling]

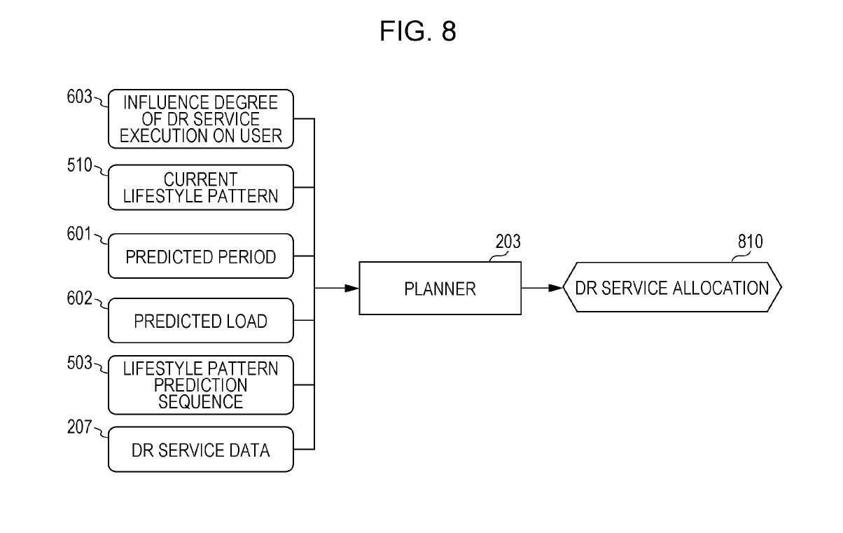

When the analyzer 202 calculates the predicted period 601, the predicted load 602, the influence degree 603, and the prediction sequence 503, the planner 203 performs DR service allocation 810 (scheduling) as illustrated in FIG. 8. FIG. 8 illustrates an overview of DR service scheduling performed by the planner 203. At this stage, not only the influence of DR service execution on the user 130 described above, but also contractual requirements for the DR service are considered.

The contractual requirements for the DR service here include, for example, “minimum period for DR service execution”, “load (power consumption) that must be lowered at minimum in DR service execution”, “energy that must be reduced at minimum in DR service execution”, and the like.

### [First DR Service Scheduling Example]

An example of DR service scheduling (allocation) will now be described. DR service allocation here is performed assuming the following.

The lifestyle pattern of a target period (predetermined period) for DR service allocation is “getting up”, and the length of this period is predicted to be 30 minutes.
Because the target period is in a weekday, a lifestyle pattern of “staying out” is predicted to follow the lifestyle pattern of “getting up”.
The past history indicates that during the lifestyle pattern of “getting up”, the user 130 does not pay attention to the setting temperature of the air conditioner and does not cancel DR service execution. However, during the lifestyle pattern of “staying out”, the user 130 switches the air conditioner off.
In the target period, the following two DR services are executed.
1≦Energy reduction involving the following contract
Operation: raise the temperature setting value and reduce energy consumption of the air conditioner
Incentive: 10 yen/kWh
Required period: no constraint
2—Reserve capacity supply involving the following contract
Operation: after a start signal is received from the utility 100, lower the load (the requirement is not satisfied if the load is off before the start signal is received)
Incentive: 40 yen/kWh at success of supply, −40 yen/kWh at failure
Required period: minimum of one hour

The planner 203 allocates the DR service of “energy reduction” to the target period in consideration of the above conditions. This is because the lifestyle pattern of “getting up” is expected to be 30 minutes, the next lifestyle pattern is “staying out”, and the air conditioner is on for 30 minutes only.

As the example described above, lifestyle patterns of the target period influence DR service allocation.

### [Second DR Service Scheduling Example]

Another example of DR service scheduling (allocation) will now be described. DR service allocation here is performed assuming the following.

The lifestyle pattern of a target period (predetermined period) for DR service allocation is “at home (active)”, and the length of this period is predicted to be five hours.
In the target period, the following two DR services are executed.
1—Peak shaving involving the following contract
Operation: reduce energy consumption at peak time periods
Incentive: 20 yen/kWh
Required period: no constraint
Mandatory load/energy change: there is no constraint on the load, but energy consumption must be reduced
2—Reserve capacity supply involving the following contract
Operation: after a start signal is received from the utility 100, lower the load (the requirement is not satisfied if the load is off before the start signal is received)
Incentive: 40 yen/kWh at success of supply, −40 yen/kWh at failure
Required period: minimum of one hour
Mandatory load/energy change: the total load must be smaller than or equal to a threshold value [kW], and the requirement is not satisfied if the total load exceeds the threshold value

The planner 203 allocates the DR service of “peak shaving” to the target period in consideration of the above conditions. The reason is as follows.

As illustrated in FIG. 2A described above, there are large load shifts and fluctuations in a lifestyle pattern of “at home (active)”. Thus, it is highly likely that some load spikes exceed the threshold value [kW]. Therefore, in the lifestyle pattern of “at home (active)”, it is much more likely that reserve capacity supply fails, and then payments are expected to increase. Accordingly, reserve capacity supply cannot be allocated to the lifestyle pattern of “at home (active)”.

As can be seen from FIG. 2C described above, large load shifts and fluctuations may occur even at night for some lifestyle patterns. Therefore, a DR service should be scheduled in consideration of lifestyle patterns, rather than being scheduled merely depending on time periods.

### [Third DR Service Scheduling Example]

The lifestyle pattern prediction sequence can also be predicted by analyzing load data for the home of the user 130. From this information, it can be predicted that the user 130 moves to “getting up” eight hours after the start of a lifestyle pattern of “sleeping” with a probability of 90%, and moves to “staying out”, which occurs only in weekdays, with a probability of 10%.

When a DR schedule is allocated, it is necessary to consider not only a lifestyle pattern of a target period, but also the use of the electrical appliance 120 in a lifestyle pattern of the next period. An influence of a lifestyle pattern of a period next to a target period on a DR service will now be described.

When a target period has a lifestyle pattern of “getting up”, it is much less likely that an EV is used in the next period. Therefore, a DR service that uses the EV battery can be allocated to the target period.

A period next to the lifestyle pattern of “getting up” is predicted to has a lifestyle pattern of “staying out” in a weekday or a lifestyle pattern of “at home (active)” in a non-working day.

During the lifestyle pattern of “staying out”, an SOC of the EV battery must be higher than or equal to 50% to maintain the functionality (moving range) required by the user. However, during the lifestyle pattern of “at home (active)” the SOC of the battery is not high in the user's priority, and even the SOC of 20% is in the allowable range. Therefore, it is considered that when the lifestyle pattern of the target period is “getting up”, an amount of power available in the target period differs depending on a lifestyle pattern of the next period.

For example, it is assumed that the following two DR services are to be executed in the target period.
1—Sell-back of energy involving the following contract
Operation: energy selling to the system
Incentive: feed-in tariff (FIT) price 40 yen/kWh
Required period: no limitation
Mandatory load/energy change: minimum of 10 kWh
2—Frequency regulation (FR) involving the following contract
Operation: based on the system frequency, continuous charge and discharge to stabilize the system frequency
Incentive: 20 yen/kWh
Required period: 30 minutes
Mandatory load/energy change: minimum battery size 10 kW (however, because in the DR controller 110, an amount of charge for 30 minutes and an amount of discharge for 30 minutes are predicted to be equal in accordance with the past data, and there is no change in SOC after 30 minutes)

When allocating “energy selling” or “FR”, the planner 203 simulates an SOC of a battery. When “energy selling” is allocated, it is considered that after the end of the target period, the SOC of the battery falls from the initial SOC of 60% to 25%. When “FR” is allocated, it is considered that because an amount of charge and an amount of discharge are equal, the SOC after the end of the target period levels off at 60%.

Therefore, if a lifestyle pattern of a period next to the target period is “staying out”, the planner 203 cannot allocate “energy selling” to the target period. This is because the user 130 cannot stay out in the next period.

However, if a lifestyle pattern of a period next to the target period is “at home (active)”, it is considered that “energy selling” satisfies the requirement in the target period.

As described above, a lifestyle pattern of a period next to a target period influences DR service scheduling in the target period.

### [Influence of a Lifestyle Pattern on an Energy Conservation DR Service]

Also in a DR service such as energy conservation, an amount of energy to be reduced and the electrical appliance 120 to be used in the DR service are influenced by a lifestyle pattern. An influence of a lifestyle pattern on the energy conservation service will now described.

The user 130 usually wants to reduce energy as much as possible. However, it is assumed that each time a lifestyle pattern is “at home (active)”, the user 130 disables the energy conservation setting and sets the indoor temperature setting of the air conditioner to a low temperature. In such a case, when a target period has the lifestyle pattern of “at home (active)”, for energy conservation, the planner 203 makes a plan for executing a DR service with the electrical appliance 120 other than the air conditioner, such as a water heater.

In this way, the planner 203 grasps, from history data such as the lifestyle pattern history 502, that when a lifestyle pattern is “at home (active)”, the user 130 does not want to set the air conditioner to the energy conservation mode.

Moreover, it is assumed that the planner 203 also grasps that when a lifestyle pattern is “sleeping”, the user 130 does not disable the energy conservation setting of the air conditioner.

When the air conditioner is on and the energy price is high, the planner 203 checks a lifestyle pattern of the user 130. When the lifestyle pattern is “at home (active)”, the planner 203 does not plan energy conservation with the air conditioner.

On the other hand, when the lifestyle pattern is “sleeping” and the energy price is high, the planner 203 plans energy conservation with the air conditioner.

Moreover, the planner 203 also grasps that the user 130 goes to sleep earlier at 22:00 or later at 1:00 AM. Then, the planner 203 allocates energy conservation with the air conditioner to a period from 22:00 to 1:00.

### [DR Service Allocation Example]

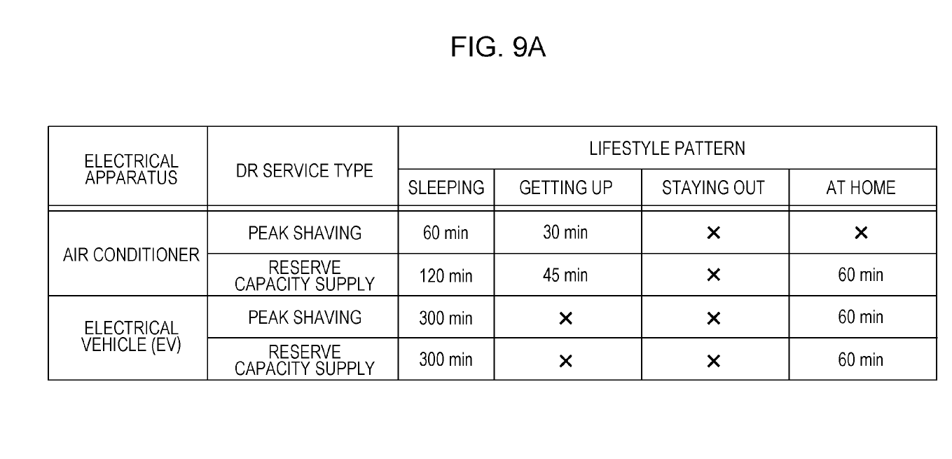

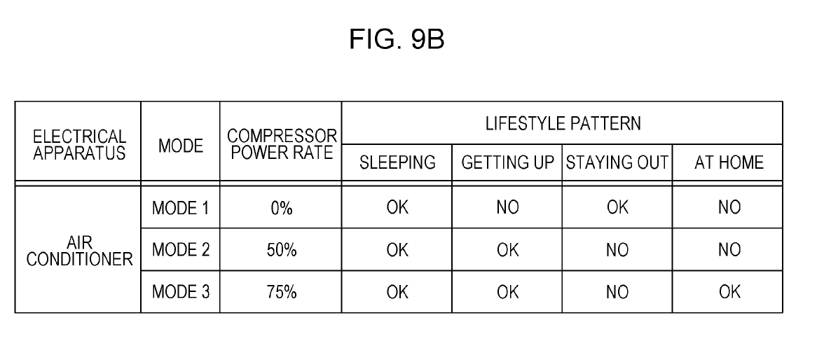

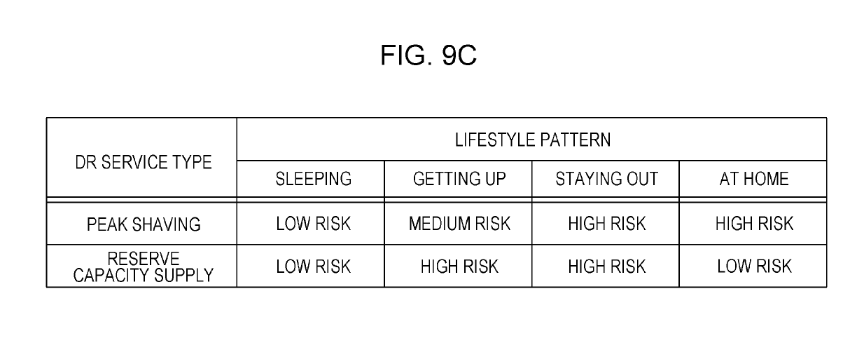

An example of DR service allocation will now be described. FIGS. 9A, 9B, and 9C illustrate DR service allocation.

As illustrated in FIG. 9A, DR service allocation includes allocation of a DR service itself and allocation of the electrical appliance 120 to be used for the DR service.

For example, in the example in FIG. 9A, when a lifestyle pattern is “sleeping” or “getting up”, peak shaving with an air conditioner may be scheduled. When a lifestyle pattern is “getting up”, for peak shaving with an air conditioner, the allowable range is 30 minutes at a maximum; when a lifestyle pattern is “sleeping”, for peak shaving with an air conditioner, the allowable range is a maximum of 60 minutes. In the example in FIG. 9A, when a lifestyle pattern is “at home (active)”, if the user 130 is more sensitive to an indoor temperature, peak shaving should not be scheduled.

DR service allocation may include decision of an operation mode of the electrical appliance 120.

In the example in FIG. 9B, in a DR service, an air conditioner is controlled in various modes with different maximum output ratings of a compressor. In mode 1, the output rating of a compressor is cut by 100% or the compressor is shut down. In mode 2, the output rating of a compressor is reduced by 50%. In mode 3, the output rating of a compressor is cut by 25%.

In mode 1, an indoor temperature rises and living comfort is lost. Therefore, mode 1 cannot be used for lifestyle patterns of “getting up” and “at home”, but can be used for lifestyle patterns of “sleeping” and “staying out”.

In mode 2, a rise in indoor temperature is slightly suppressed, and therefore this mode can be used for a lifestyle pattern of “getting up”. However, mode 2 should not be used for lifestyle patterns of “at home (active)” and “staying out”. Mode 3 can be used for any lifestyle pattern except “staying out”.

As illustrated in FIG. 9C, DR service allocation includes determination of a possibility of DR service failure depending on lifestyle patterns. A failure probability may depend on load distribution of a lifestyle pattern or a use pattern of the electrical appliance 120.

In the contract of a reserve capacity supply DR service, the DR controller 110 must maintain a home demand (home power consumption) at a level lower than a threshold value [kW] during service time. If the DR controller 110 cannot maintain reduction in home demand throughout the period during which the DR service is provided, the DR service fails.

Referring to home load shifts illustrated in FIG. 2B described above, when lifestyle patterns are “at home (active)” and “getting up”, load shifts are quite large and load spikes are present, regardless of times of day. However, when the user is sleeping, that is, in the case of “at home (inactive)”, load shifts are quite small and load spikes are small, regardless of times of day. That is, the planner 203 can determine that when lifestyle patterns are “at home (active)” and “getting up”, if reserve capacity supply is allocated, reserve capacity supply (DR service) will fail with a high probability. Therefore, this scheduling is not performed.

Peak shaving and reserve capacity supply are DR services that assume that load (power consumption) is reduced while the electrical appliance 120 is operated. When a lifestyle pattern is “staying out”, the electrical appliance 120 is not usually operated, and therefore peak shaving and reserve capacity supply do not satisfy the requirements. Accordingly, in this case, the planner 203 does not allocate peak shaving and reserve capacity supply.

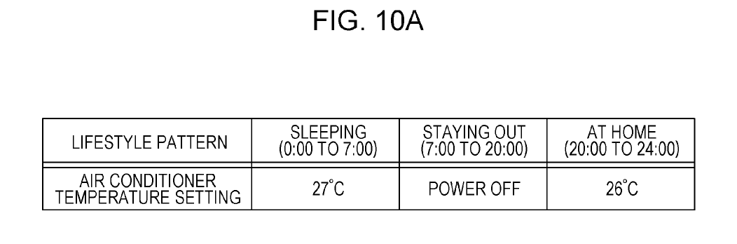

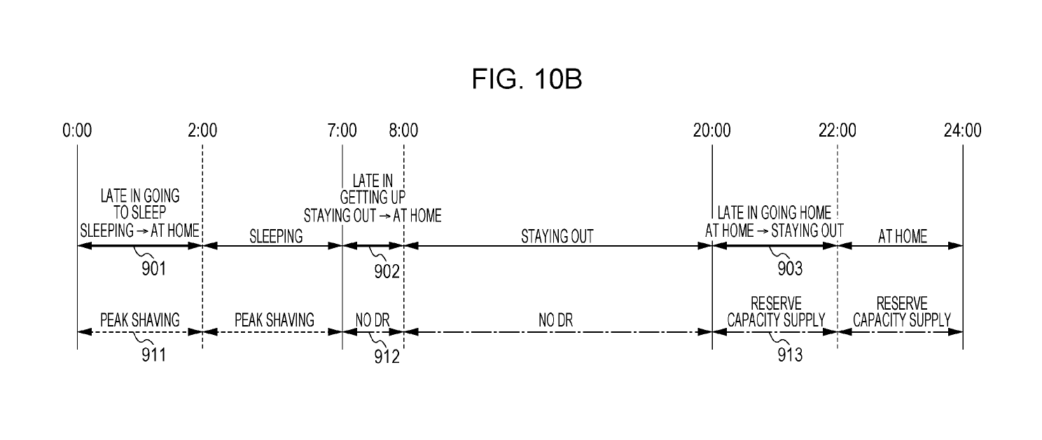

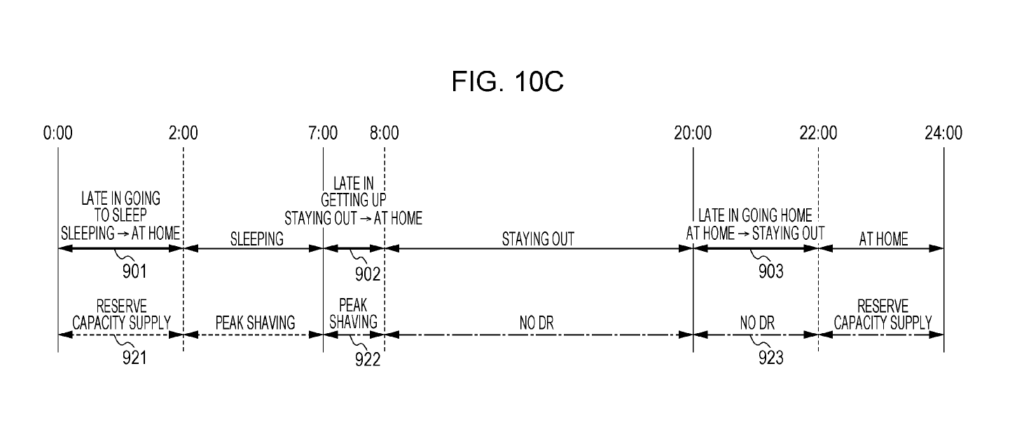

Finally, scheduling by the planner 203 will be described with comparative examples. FIGS. 10A, 10B, and 10C illustrate scheduling by the planner 203.

For example, consider the user 130 who made air conditioner temperature settings as illustrated in FIG. 10A. In this case, the planner 203 simulates an influence of each DR service on an indoor temperature based on the air conditioner temperature settings essential to the user 130. As a result, an influence on the user is decided when the DR services as illustrated in FIG. 7C are executed.

FIG. 10B illustrates a comparative example in which DR services are allocated depending on time periods, without consideration of lifestyle patterns of the user 130.

In the example in FIG. 10B, peak shaving 911 is allocated to a period 901 in consideration of time periods. However, the user 130 is actually late in going to sleep, has not yet gone to sleep, and is active in the home. In this case, because comfort of the user 130 is lost by the peak shaving 911, the user 130 may cancel the peak shaving 911.

Moreover, in the example in FIG. 10B, in a period 902 during which the user 130 was supposed to stay out, the DR controller does not any DR (denoted as No DR 912 in FIG. 10B). In the period 902, because the user 130 is late in getting up and is actually sleeping, an air conditioner can be used for peak shaving. Therefore, profits are lost.

Moreover, in the example in FIG. 10B, in a period 903, the DR controller starts reserve capacity supply 913, assuming that the user 130 is at home. However, the user is actually not at home. Therefore, the user is actually late in going home, and is staying out. Thus, in the period 903 for which a lifestyle pattern is actually “staying out”, because it is much more likely that reserve capacity supply fails as illustrated in FIG. 9C, scheduling is not suitable.

In contrast, the DR controller 110 determines lifestyle patterns, allocates peak shaving to a lifestyle pattern of “sleeping” (period with this pattern), does not allocate a DR service to a lifestyle pattern of “staying out”, and allocates reserve capacity supply to a lifestyle pattern of “at home”.

Also in FIG. 10C, the period 901 should have “sleeping”, but actually has “at home (active)”. The DR controller 110 determines that the lifestyle pattern of the period 901 is “at home (active)”, and allocates reserve capacity supply 921, instead of peak shaving. This improves comfort of the user 130 and reduces a probability that the DR service is cancelled.

Similarly, the period 902 should have “staying out”, but actually has a lifestyle pattern of “sleeping”. The DR controller 110 determines that the lifestyle pattern of the period 902 is “at home (active)”, and allocates peak shaving 922, instead of “No DR”. This increases an incentive that the user 130 can obtain.

Also in the period 903, No DR 923 for a lifestyle pattern of “staying out” is allocated, instead of reserve capacity supply that should be allocated to a lifestyle pattern of “at home (active)”. This can reduce a probability that reserve capacity supply fails.

### [Conclusion]

The DR system 10 according to the first embodiment has been described above.

The demand response control method according to the first embodiment adjusts power supply and demand in a power system by controlling the electrical appliance 120 in a supply and demand adjustment period. The above demand response control method includes the second acquisition step that acquires information about a supply and demand adjustment service with which the user 130 has a contract (S12 in FIG. 4), the estimation step that estimates a lifestyle pattern of the user 130 in the supply and demand adjustment period using the acquired lifestyle pattern information (S13 in FIG. 4), the planning step that, based on the estimated lifestyle pattern and the supply and demand adjustment service information, generates an operation plan (execution plan) for the electrical appliance for executing the supply and demand adjustment service in the supply and demand adjustment period (S14 in FIG. 4), and the execution step that controls the electrical appliance in accordance with the operation plan in the supply and demand adjustment period (S20 in FIG. 4). The supply and demand adjustment service, the estimation step, and the operation plan correspond to the DR service, the determination step, and the execution plan of the above first embodiment, respectively.

This demand response control method can provide a supply and demand adjustment service in consideration of an influence on comfort of the user 130. In addition, an appropriate supply and demand adjustment service is allocated to a predetermined period, and it is therefore possible to reduce a probability that reserve capacity supply fails (does not satisfy requirements of the utility 100).

The supply and demand adjustment period is any period to which a supply and demand adjustment service is allocated. The supply and demand adjustment period may be a period delimited for each lifestyle pattern as in the first embodiment, or may be a time unit for a supply and demand adjustment service, the time unit being identified by supply and demand adjustment service information provided from the utility 100.

Moreover, in the above first embodiment, although information about a lifestyle pattern of the user 130 is generated from the load data 205, the DR controller 110 may acquire, from the outside, lifestyle pattern information for estimating a lifestyle pattern. That is, the above demand response control method may include a first acquisition step that acquires lifestyle pattern information of the user 130.

Moreover, as described in, for example, FIGS. 9A to 9C, in the above supply and demand adjustment period, a plurality of DR services (for example, peak shaving and reserve capacity supply) are execution targets. Therefore, in the planning step, one of the plurality of supply and demand adjustment services is selected based on the estimated lifestyle pattern and an operation plan is generated in which the selected one supply and demand adjustment service is allocated to the above supply and demand adjustment period.

For example, in the planning step, the supply and demand adjustment service in which reduction of power consumption of the electrical appliance is requested (for example, peak shaving and reserve capacity supply) is allocated to the supply and demand adjustment period that is estimated as a period during which the user 130 is sleeping. In addition, for example, in the planning step, the supply and demand adjustment service in which reduction of power consumption of the electrical appliance 120 is requested is not allocated to the supply and demand adjustment period that is estimated as a period during which the user 130 stays out.

Moreover, the above demand response control method may include, after the planning step, a third acquisition step that acquires a state of the user 130 in the supply and demand adjustment period (S18 in FIG. 4), and an update step that updates the operation plan based on the acquired state of the user 130 (S19 in FIG. 4).

The state of the user 130 here is, for example, an actual lifestyle pattern input by the user 130 through the input interface 208 or a smartphone or the like owned by the user 130. When the state of the user 130 is thus input, the operation plan is modified appropriately to reflect a real condition, and a supply and demand control service is implemented in consideration of an influence on comfort of the user 130.

### Second Embodiment

In a second embodiment, a demand response control method (demand response control device) is described which compares an action schedule indicating an expected action of the user and a control schedule for the electrical appliance 120 in a supply and demand adjustment period to determine whether power supply and demand can be adjusted.

Here, the action schedule corresponds to the state of the user 130 of the above first embodiment, and the control schedule corresponds to the execution plan of the above first embodiment.

In this demand response control method, an acquired action schedule and a generated control schedule are compared to determine whether power supply and demand in a supply and demand adjustment period can be adjusted. When it is determined that the power supply and demand can be adjusted, the electrical appliance 120 is controlled in accordance with the control schedule in the supply and demand adjustment period.

The action schedule is acquired, for example, from the input interface 208 or a smartphone owned by the user 130. The action schedule may be acquired, for example, through an application that is downloaded to a mobile terminal such as a smartphone and manages a schedule of the user 130.

This demand response control method also can provide a supply and demand adjustment service in consideration of an influence on comfort of the user.

This demand response control method may further include a step that, when it is determined that the power supply and demand cannot be adjusted, displays advice information for enabling adjustment of the power supply and demand on a predetermined displayer.

This advice information here is, for example, a message for making the user 130 turn off the electrical appliance 120 (suppress power consumption). More specifically, the advice information is, for example, a message indicating that when the setting temperature of the air conditioner is lowered, the power supply and demand can be adjusted.

The predetermined displayer is a display provided in the DR controller 110. The predetermined displayer may be a display of a smartphone, or a personal computer, owned by the user 130. In this case, the advice information is transmitted from the server 150 or the DR controller 110 to the smartphone or the personal computer.

This demand response control method may further include a step that, when it is determined that the power supply and demand cannot be adjusted, displays information about a user loss due to non-adjustment of the power supply and demand on the predetermined displayer. The user loss information is, for example, an amount of the consideration 103 that would be obtained if the power supply and demand was adjusted.

This configuration can encourage the user 130 to participate in the power supply and demand adjustment.

### Another Embodiment

The demand response control method and the demand response control device according to the first and second embodiments have been described above, but the present disclosure is not limited to the first and second embodiments.

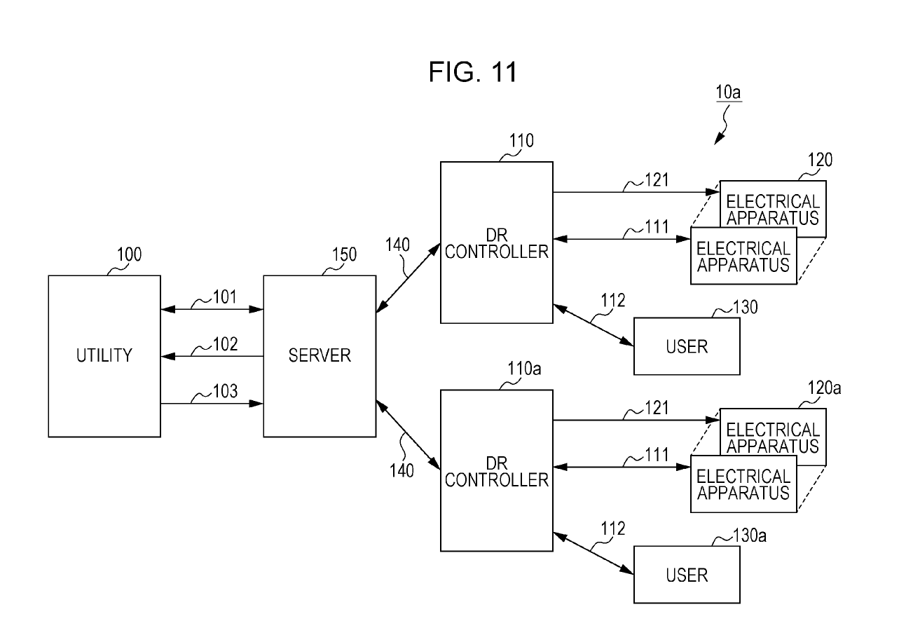

For example, the demand response control device of the present disclosure may be implemented as a server that coordinates a plurality of DR controllers. FIG. 11 is a system configuration diagram illustrating a configuration of a DR system including a server that coordinates a plurality of DR controllers. Differences from the DR system 10 are mainly described below, and repeated descriptions may be omitted.

In addition to the configuration of the DR system 10, a DR system 10a illustrated in FIG. 11 further includes a server 150, a DR controller 110a, and a plurality of electrical appliances 120a. In FIG. 11, a user 130a of the DR controller 110a is illustrated.

This DR system 10a has a configuration to be assumed when a plurality of users 130 and 130a live in separate spaces, as in, for example, a collective housing and DR services are performed in the whole collective housing. Moreover, the present embodiment is also applicable when DR services are performed for each community including a plurality of consumers.

The utility 100 transmits and receives the data 101 to and from the server 150. The utility 100 is, for example, a power company or a system operating company that operates a power system.

The server 150 provides the service 102 to the utility 100. In addition, the server 150 generates an operation plan for executing the DR service. Further, the server 150 transmits data 140 (control signal) to the DR controllers 110 and 110a to make the DR controllers 110 and 110a control the electrical appliances 120 and 120a. The server 150 is, for example, a server used by an aggregator.

In the DR system 10a, the server 150 can acquire a state of the user 130 and a state of the user 130a through the DR controllers 110 and 110a, and update the operation plan based on the acquired state of the user 130 and the acquired state of another user 130a. Thus, if the DR service becomes suddenly unable to be executed for the electrical appliance 120 in the home of the user 130, the DR service can be executed for the electrical appliance 120a in the home of the user 130a, instead. That is, for the whole collective housing, it is possible to reduce a probability that the DR service fails.

In the DR system 10a, the server 150 transmits and receives the data 140 to control the DR controllers 110 and 110a, but the DR controllers may coordinate with each other directly.

A lifestyle pattern determination method in the DR systems 10 and 10a is not limited to the determination method described in the first embodiment. For lifestyle pattern determination, another method, such as the method described in U.S. Patent Application Publication No. 2011/0046805, may be used.

In the above embodiments, components (for example, components included in the controller 200) may be configured with dedicated hardware, or may be implemented by executing a software program suitable for the components. The components may also be implemented through a program execution unit such as a CPU or a processor by reading and executing a software program recorded on a recording medium such as a hard disk or semiconductor memory.

Moreover, in the above embodiments, processing executed by a specific processing unit may be executed by another processing unit. Further, a sequence of a plurality of types of processing may be changed, and a plurality of types of processing may be executed in parallel.

It should be noted that generic or specific embodiments of the present disclosure may be implemented as a system, a method, an integrated circuit, a computer program, a computer-readable recording medium such as a CD-ROM, or any selective combination thereof. For example, the present disclosure may be implemented as the above DR systems 10 and 10a.

The present disclosure is not limited to these embodiments or their modifications. Embodiments obtained by applying various modifications conceived by those skilled in the art to the present embodiments or their modifications, or embodiments configured by combining components of different embodiments or their modifications are also included in the scope of the present disclosure, without departing from the spirit of the present disclosure.

The present disclosure is useful in providing DR services that control electrical appliances to adjust power supply and demand in a power system.

What is claimed is:

1. A demand response control method for an electric power storage device, the method comprising:
acquiring consumption power of a user and information about one or more demand response services with which the user has a contract;
estimating a lifestyle pattern in a demand control period according to the consumption power;
assigning one of a plurality of demand control services to the demand control period according to the lifestyle pattern and generating operation plan of one or more electric appliances to perform demand control services; and
controlling the electric appliances according to the operation plan in the demand control period.

2. The demand response control method according to claim 1, wherein the demand control service is either a peak shaving control or a frequency control.

3. The demand response control method according to claim 1, wherein the lifestyle pattern is one of “active at home”, “inactive at home”, “getting up”, “sleeping”, and “absence”.

4. The demand response control method according to claim 1, wherein the demand response service includes service for a reduction of power consumption of the electrical appliance, and the service for a reduction of power consumption is assigned to the demand control period if the lifestyle pattern is “sleeping”.

5. The demand response control method according to claim 1, wherein the demand response service includes service for a reduction of power consumption of the electrical appliance, and the service for a reduction of power consumption is not assigned to the demand control period if the lifestyle pattern is “absence”.

6. A demand response control device for an electric power storage device, the device comprising:
one or more memories; and circuitry operative to:
acquire consumption power of a user and information about one or more demand response services with which the user has a contract;
estimate a lifestyle pattern in a demand control period according to the consumption power;
assign one of a plurality of demand control services to the demand control period according to the lifestyle pattern and generating operation plan of one or more electric appliances to perform demand control services; and
control the electric appliances according to the operation plan in the demand control period.
